(19) United States
(12) Patent Application Publication
(10) Pub. No.: US 2025/0229972 A1
(43) Pub. Date: Jul. 17, 2025

(54) FACIAL TISSUE DISPENSING AND DISPOSAL DEVICE

(71) Applicant: Evelyn Wilson, Philadelphia, PA (US)

(72) Inventor: Evelyn Wilson, Philadelphia, PA (US)

(21) Appl. No.: 19/027,152

(22) Filed: Jan. 17, 2025

Related U.S. Application Data
(60) Provisional application No. 63/621,718, filed on Jan. 17, 2024.

(51) Int. Cl. B65D 83/08; A45D 40/00; A45D 40/24; F21V 33/00

(52) U.S. Cl. CPC B65D 83/0805; A45D 40/24; B65D 83/0888; F21V 33/0064; A45D 2040/0006

(57) ABSTRACT

A tissue dispensing and disposal device includes a support body and one or more tissues dispensable from the support body. The device features a plurality of expandable disposal portions, each designed to receive a tissue and configured to separate from the support body. This configuration allows for efficient dispensing and disposal of tissues, facilitating hygienic use and disposal, and providing improved convenience. Embodiments are suitable for use in a vehicle, as an accessory to a handkerchief or article of clothing, or with a pocketbook.

### CROSS REFERENCE TO RELATED APPLICATION

This application claims the benefit of U.S. Provisional Application No. 63/621,718, filed Jan. 17, 2024, which is hereby incorporated in its entirety.

### TECHNICAL FIELD

The present invention pertains generally to dispensers for tissue, paper products, or the like with means for storing soiled products, and more particularly to facial tissue dispensing and disposal devices and methods of use.

### BACKGROUND

Handling used sanitary products, such as facial tissues, can spread germs, dirt, and the like onto the handler's hands as well as to surfaces that may be contacted by others. It is difficult for ordinary users to minimize contact with such used products when disposing of them, especially in environments such as vehicles or public settings.

There is a need in the art for improved devices for dispensing and disposing of facial tissues in a sanitary manner.

### BRIEF SUMMARY OF THE EMBODIMENTS

Embodiments disclosed herein are directed to tissue dispensing and disposal devices which provide improved convenience and sanitation. Various disclosed embodiments of tissue dispensing and disposal devices may be suitable for use in a vehicle, on a desktop or tabletop, as an accessory to a handkerchief or article of clothing, in a pocketbook or backpack, at the side of a bed, or in other convenient locations. The tissue dispensing and disposal device dispenses tissues and provides removable, expandable disposal portions for sanitary disposal of used tissues. The device may also provide sterilization, skin care products, or illumination.

According to one or more examples, a tissue dispensing and disposal device includes: a support body; one or more tissues supported by the support body and dispensable therefrom; a plurality of expandable disposal portions affixed to the support body, each of the expandable disposal portions having an aperture configured to receive one of the one or more tissues therethrough and each of the expandable disposal portions being expandable to contain one of the one or more tissues; and wherein each of the expandable disposal portions is structurally configured for separation from the support body.

According to one or more examples of a tissue dispensing and disposal device, the plurality of expandable disposal portions are affixed to an exterior face of the support body.

According to one or more examples of a tissue dispensing and disposal device, the one or more tissues are dispensable from a central region of the support body and the plurality of expandable disposal portions at least partially surround the central region.

According to one or more examples of a tissue dispensing and disposal device, the plurality of expandable disposal portions are each connected to another of the plurality of expandable disposal portions and are readily separable therefrom.

According to one or more examples of a tissue dispensing and disposal device, the plurality of expandable disposal portions, when connected to one another, form an accordion shape.

According to one or more examples, a tissue dispensing and disposal device further includes an illumination source structurally configured to illuminate one or more of the plurality of expandable disposal portions.

According to one or more examples of a tissue dispensing and disposal device, the illumination source is located within the support body.

According to one or more examples, a tissue dispensing and disposal device further includes a rotatable portion adjacent a top of the support body, the rotatable portion positionable to expose at least one of the expandable disposal portions.

According to one or more examples, a tissue dispensing and disposal device further includes at least one of a sanitizer dispenser and a moisturizer dispenser affixed to the support body.

According to one or more examples, a tissue dispensing and disposal device further includes: a passage shaped and dimensioned to retain a handkerchief; a wrapper affixed to the passage and having an opening on an end; the support body being located within the wrapper and slidably positionable within the wrapper along a first direction to extend through the opening; the plurality of expandable disposal portions being retained adjacent to the support body within the wrapper; and wherein, when the support body is slidably positioned to at least partially extend from the wrapper, at least one of the plurality of expandable disposal portions is exposed for removal from the device.

According to one or more examples of a tissue dispensing and disposal device, the passage is formed within a resilient clip.

According to one or more examples of a tissue dispensing and disposal device, each of the plurality of expandable disposal portions has a layered structure including a first layer including a reflective region, a second layer including at least one of a sanitizer dispenser and a moisturizer dispenser, and a third layer including an expandable bag.

According to one or more examples of a tissue dispensing and disposal device, the layered structure includes a fourth layer including one or more tissues.

According to one or more examples of a tissue dispensing and disposal device, the passage is sized to contain at least three handkerchiefs.

According to one or more examples of tissue dispensing and disposal device, the wrapper has two openings, one of the two openings located on each of two opposing ends of the wrapper.

According to one or more examples, a tissue dispensing and disposal device further includes: at least three expandable disposal portions retained adjacent to the support body within the wrapper, the at least three expandable disposal portions arranged linearly along the first direction.

According to one or more examples of a tissue dispensing and disposal device, when the support body is slidably positioned to at least partially extend from the wrapper, the expandable disposal portion is ejected from the device. Independent method of using any of the described devices

According to one or more examples, a method of using a tissue dispensing and disposal device includes: a) dispensing a tissue from a support body; b) removing an expandable disposal portion from the device, the expandable disposal portion having an aperture configured to receive the tissue therethrough and being expandable to contain the tissue; c) using the tissue; d) after step c, disposing of the tissue by inserting it through the aperture of the expandable disposal portion; e) dispensing at least one of a sanitizer and a moisturizer from a dispensing region; f) disposing of the expandable disposal portion; and g) applying at least one of the sanitizer and the moisturizer to a user's hand. Dependent method for just the handkerchief version

According to one or more examples, the method further includes: in step (a), sliding the support body out of a wrapper through an opening to expose at least one expandable disposal portion and at least one tissue.

These and other aspects of the embodiments will be better appreciated and understood when considered in conjunction with the following description and the accompanying drawings. The following description, while indicating various embodiments and details thereof, is given by way of illustration and not of limitation. Many substitutions, modifications, additions, or rearrangements may be made within the scope of the embodiments, and the embodiments may include all such substitutions, modifications, additions, or rearrangements.

### BRIEF DESCRIPTION OF THE DRAWINGS

Non-limiting and non-exhaustive embodiments of the facial tissue dispensing and disposal device are described with reference to the following figures, wherein like reference numerals refer to like parts throughout the various views unless otherwise specified.

FIG. 1 is a perspective view of an exemplary embodiment of a tissue dispensing and disposal device.

FIG. 2 is a partial perspective view of an exemplary embodiment of a tissue dispensing and disposal device.

FIG. 3 is a perspective view of another exemplary embodiment of a tissue dispensing and disposal device.

FIG. 4 is a front view of an embodiment of a handkerchief device.

FIG. 5 is a rear view of an embodiment of the handkerchief device.

FIG. 6 is a perspective view of an embodiment of an expandable disposal portion.

FIG. 7 is an exploded perspective view of an embodiment of the expandable disposal portion.

FIG. 8 is a front perspective view of an embodiment of the handkerchief device.

FIG. 9 is a rear perspective view of an embodiment of the handkerchief device.

FIG. 10 is a partially exploded perspective view of an embodiment of the handkerchief device.

FIG. 11 is a view of an embodiment of the handkerchief device in a first position of use.

FIG. 12 is a view of an embodiment of the handkerchief device in a second position of use.

FIG. 13 is a view of an embodiment of an expandable disposal portion in a first position of use.

FIG. 14 is a view of an embodiment of the expandable disposal portion in a second position of use.

FIG. 15 is an illustration of a first step of a method of using a tissue dispensing and disposal device, in accordance with an embodiment.

FIG. 16 is an illustration of a second step of a method of using a tissue dispensing and disposal device, in accordance with an embodiment.

FIG. 17 is an illustration of several steps of a method of using a tissue dispensing and disposal device, in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. Also, common but well-understood elements that are useful or necessary in a commercially feasible embodiment are often not depicted in order to facilitate a less obstructed view of these various embodiments.

### DETAILED DESCRIPTION OF THE INVENTION

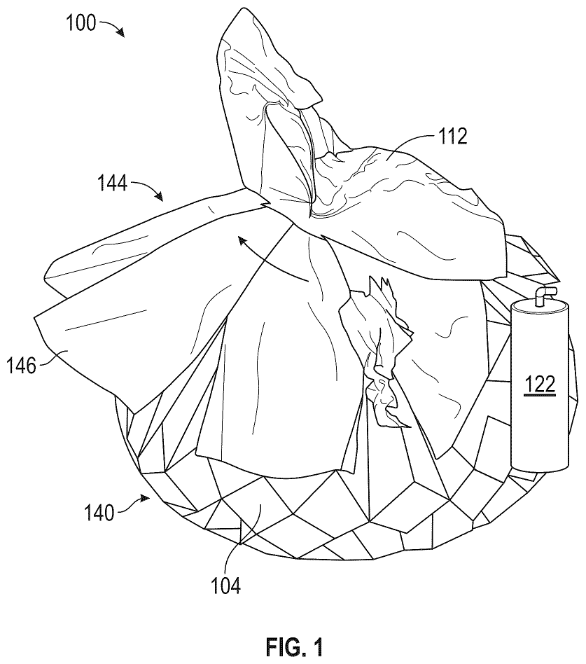

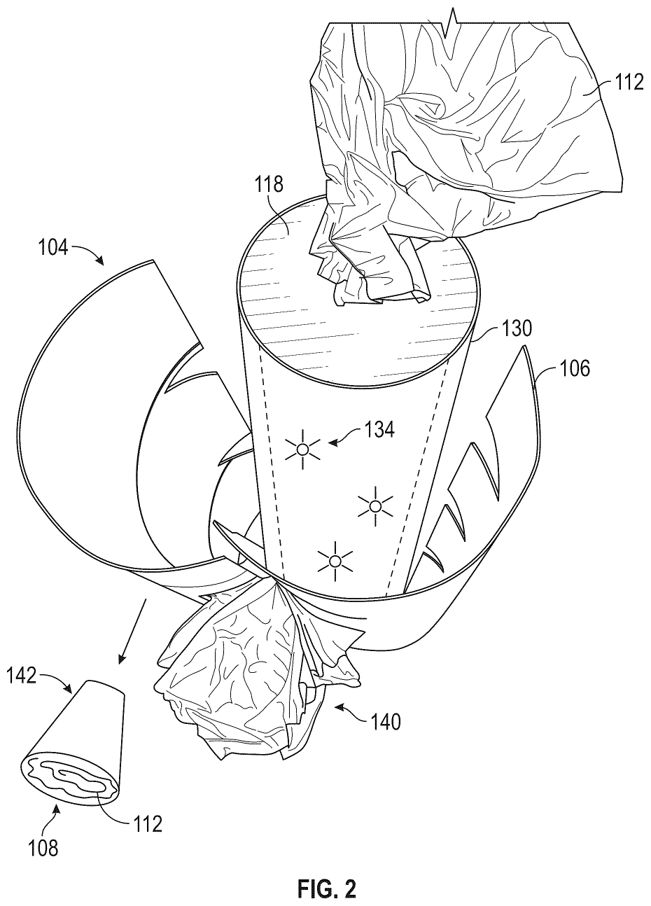

Referring initially to FIGS. 1-2, there are illustrated perspective views of an exemplary embodiment of a tissue dispensing and disposal device 100, which may also be referred to herein as simply the device 100. Tissue dispensing and disposal device 100 includes a support body 106, one or more tissues 112, and a plurality of expandable disposal portions 104. The device 100 is generally configured such that the tissues 112 are dispensable from the support body 106. Each tissue (for example, after use—e.g., when soiled) may be inserted into one of the expandable disposal portions 104, which is configured to expand to contain the tissue. The expandable disposal portions 104 are configured to be separated from the support body 106, and, once separated, may be transported, disposed of, or otherwise handled by a user without the user contacting the soiled tissue that may be contained within. This arrangement allows a user to transport used tissues (e.g., in a purse, bag, vehicle, by hand, or the like) in a sanitary manner prior to disposal.

The support body 106 supports one or more tissues which are dispensable from the support body. For example, as shown in FIG. 2, the support body 106 may have a generally cylindrical shape, and tissues may be stored within an interior of the support body and may be dispensed therefrom, such as from a top or a side of the support body. The support body 106 may have numerous other shapes, as will be described herein. Similarly, various other dispensing arrangements for tissues are possible. The support body 106 also supports a plurality of expandable disposal portions 104 which are affixed to the support body 106. The expandable disposal portions 104 may be affixed to the support body 106 in various ways, such as by extending from openings in the support body (see, e.g., FIG. 2), being wrapped around the support body, being retained against the support body (e.g., by a wrapper), being adhered, or otherwise affixed, to an exterior face of the support body, being dispensable from the support body, or via similar methods. Other features of the device may also or instead be affixed to the support body, such as, but not limited to: an illumination source, a rotatable portion, a dispenser (e.g., for sanitizer or moisturizer), or a device mount (such as suction-type mount or an adhesive-type mount).

The one or more tissues 112 may be arranged for dispensing from the support body 106, and as such, may have a folded, a stacked, an interconnected, or a similar arrangement configured to aid in dispensing. The one or more tissues 112 may, for example, be contained within, or affixed to, a central region 130 of the support body 106. As used herein, the term “tissue” may refer to a facial tissue, dry or wet wipe, napkin, paper towel, or a similar disposable product.

The expandable disposal portions 104 are configured to contain a tissue 112 within in a manner that permits a user to handle the expandable disposal portion 104 without coming into further contact with the tissue (e.g., after inserting the tissue into the disposal portion). The expandable disposal portion 104 may have an aperture 108 through which the user may insert the tissue. The expandable disposal portion expands to contain the tissue; for example, the expandable disposal portion 104 as shown in FIGS. 1 & 2 may be in a collapsed position or a folded position which expands (e.g., unfolds) when the tissue is inserted. In other arrangements, the expandable disposal portion 104 may have an elastic portion (e.g., surrounding the aperture 108 which can be manually expanded by the user when inserting the tissue.

The expandable disposal portion 104 is structurally configured to be readily separable from the support body (e.g., without damaging the support body or exposing the tissue within the disposal portion). For example, an expandable disposal portion 104 may have a perforated or otherwise frangible connection to the device, which is readily separable in a non-destructive manner. As shown in FIG. 2, the expandable disposal portions 104 may each form a segment 142 of a segmented body 140 (one segment 142 is shown separated from the support body 106 along the directional arrow of FIG. 2). Each segment 142 may be shaped and configured to receive at least one tissue 112 (e.g., a used tissue) therein, such as through an aperture 108. Each segment 142 may be shaped and dimensioned to hold a used tissue therein (e.g., in a folded, crumpled, or similar shape), and may also, or instead, be shaped to retain the tissue. Said another way, segment 142 may be shaped or structured so that the used tissue does not readily fall out of segment 142. For example, segment 142 may have a substantially frustoconical shape, or another shape with a relatively wide opening that tapers to a more narrow bottom opposite the opening. Each segment 142 may be readily removable from the segmented body 140, e.g. segment 142 may be perforated or otherwise frangible; in this manner a user may insert a used tissue 112 into a segment and then remove the segment 142 from the segmented body 140 for disposal, thereby keeping the segmented body 140 relatively free of germs, dirt, or the like. In other embodiments, the expandable disposal portion 104 may be removed from the device prior to inserting the used tissue therein.

In some embodiments, the support body 106 may have a central region 130 from which tissues are dispensed, and a plurality of expandable disposal portions 104 may at least partially surround the central region (see, e.g., centrally located support body of FIG. 2 and the surrounding expandable disposal portions 104 of FIG. 1). In other embodiments, the support body 106 may surround a cooperating member, such as a box of facial tissues. Said another way, a box of tissues, or other cooperating member may be at least partially surrounded by a support body 106 which may include any of the features described herein with respect to other embodiments.

A rotatable portion 144 may be located adjacent a top of the support body 106, and may include one or more tabs 146. The rotatable portion 144 may be rotatably positionable to expose at least one of the expandable disposal portions. For example, by rotating the rotatable portion 144 (e.g., along the directional arrow of FIG. 1), one or more expandable disposal portions 104 may be exposed between the tabs 146, while others may be covered by a tab 146. In this manner, unused segments 142 may be revealed for easy access while used segments, or areas from which segments have been removed, may be concealed (e.g., by a tab 146). Said another way, tabs 146 may provide a tactile guide enabling a user to readily find an unused segment 142 without visually focusing on the device (which may be desirable, for example, when the device is used in a vehicle). In addition, or instead, used segments 142 may be covered by tab 146 (e.g., before a user is able to remove such segments); this feature may provide improved sanitation by preventing exposure to used tissues contained within such segments. Expandable disposal portions 104 similar to that shown and described in the embodiment of FIGS. 1-2 may be included in other embodiments described herein, although they may not be explicitly shown in such figures.

The tissue dispensing and disposal device 100 may include a reflective region 118, such as shown at the top of the central region 130 in FIG. 2. This feature may be used as a mirror, in which a user may examine their face or the like.

The tissue dispensing and disposal device 100 may include, or may cooperate with, one or more dispensers 122 which may dispense sanitizer, moisturizer, or the like. The dispenser 122 may be affixed to the support body. In the case of a cooperating dispenser, a lotion bottle or sanitizer bottle, for example, may be provided by a user. The device 100 may include structural features for coupling the cooperating dispenser to the device, such as a retaining or mounting mechanism.

The tissue dispensing and disposal device 100 may include an illumination source 134, which may be used, for example, for disinfecting purposes. For example, the illumination source 134 of FIG. 2 is located within the central region 130 of the support body 106. The illumination source 134 may be structurally configured to illuminate one or more of the expandable disposal portions 104 (e.g., from behind). For example, the illumination source 134 may be an ultraviolet radiation source suitable for disinfecting purposes (e.g., an ultraviolet illumination source providing light in the far UV-C region between about 200 nm and 280 nm). In such an example, illumination source 134 may be activated for a sufficient duration, and may provide a sufficient intensity, to substantially disinfect a used tissue 112 or other item. The illumination source 134 may include one or more LEDs, lamps, bulbs, or other suitable source of light, and may also include electronics for power and/or control.

The embodiment of FIGS. 1-2 may be suitable for use in a vehicle, and may be mounted to a console, concealed inside of a glovebox or console, or placed in other locations in or on the vehicle. The device 100 may include a mount affixed to the support body 106, such as a suction-type mount, an adhesive-type mount, or the like. It will be understood that this, or other embodiments, may be used in other locations, such as on a desktop, at a bedside, in a pocketbook, a backpack, etc.

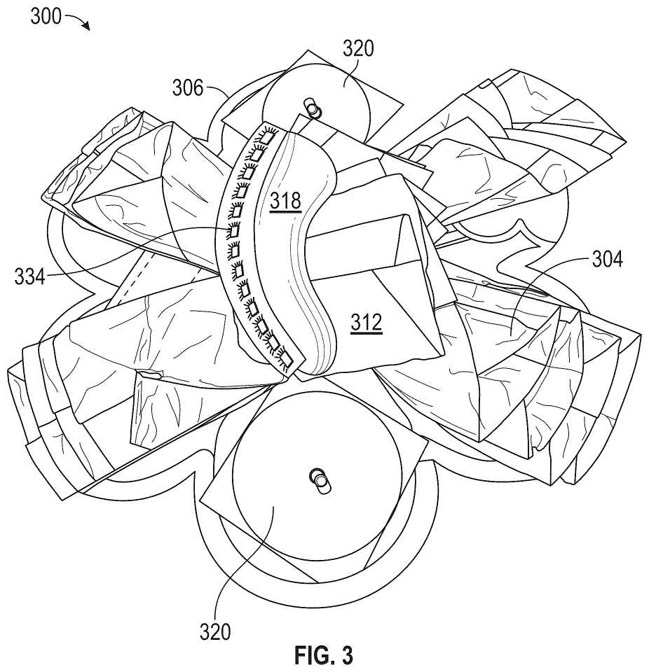

FIG. 3 is a perspective view of another exemplary embodiment of a tissue dispensing and disposal device 300. Tissue dispensing and disposal device 300 may include features the same as, or similar to, those described elsewhere herein with reference to other embodiments, and like reference numbers are used to refer to like parts. Tissue dispensing and disposal device 300 may include a support body 306, one or more tissues 312, expandable disposal portions 304, a dispensing region 320, a reflective region 318, and an illumination source 334.

The support body 306 may generally have a flower-like shape, as shown, or may be shaped in other aesthetically pleasing or artistic ways. In the shown embodiment, one or more disposal portions 304 may be shaped and arranged like petals of a flower. The support body 306, and/or the overall device 300, may be substantially flat and relatively thin. Such a configuration may be preferred for placement on the outside of a pocketbook, bag, or the like, or may be conveniently placed inside a bag, briefcase, or the like.

The tissues 312 may be affixed to a surface of the support body 306, may be dispensed through a slit in the support body, or may be dispensed in another manner. The disposal portions 304 may include a segmented body with a plurality of segments, which may be similar to other disposal portions described herein. The disposal portions 304 may also, or instead, be configured as removable layers, as described for example, with respect to the support body 106 of FIGS. 1-2. To insert a tissue 312 into one of the disposal portions 304, a user may remove the disposal portion 304 from the support body 306 (e.g., by detaching a segment as described herein, by removing an adhered portion, or the like). Alternatively, the disposal portions 304 main remain attached to the support body 306 after use; in such a case at least a portion of the disposal portion 304 may be folded, slid away, or otherwise repositioned to mitigate potential exposure to any used tissue within the disposal portion 304.

The dispensing region 320 may include, for example, a sanitizer dispenser or a moisturizer dispenser which may have, e.g., a blister-pack type of construction that allows the user to break open the packaging with their hand and dispense a small amount of sanitizer or moisturizer. The illumination source 334 may be used, for example, in conjunction with the reflective region 318 for a user to illuminate and examine their face.

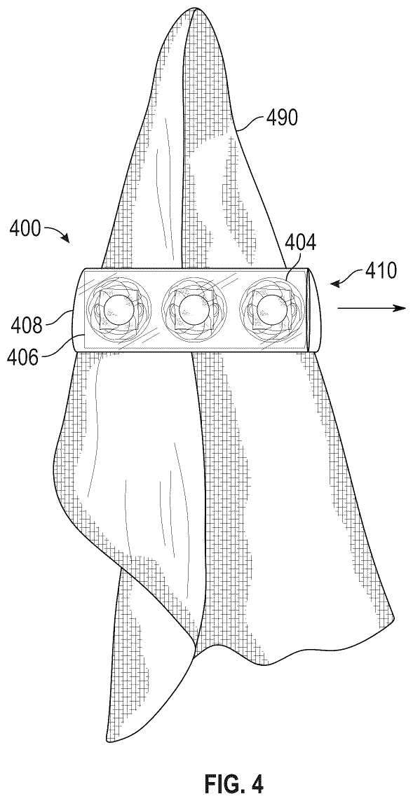

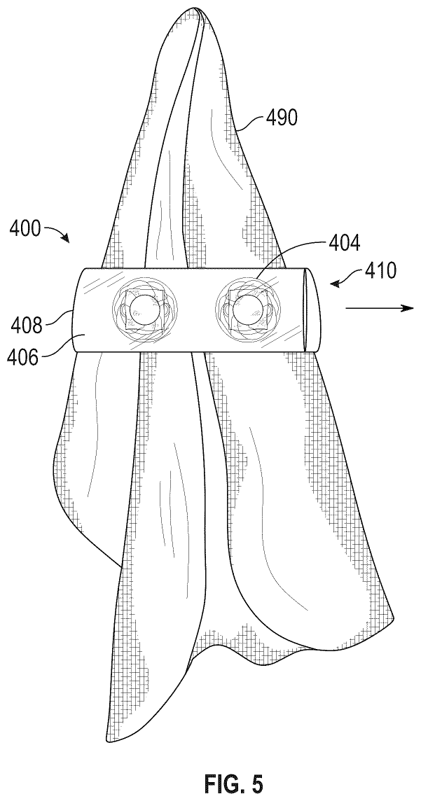

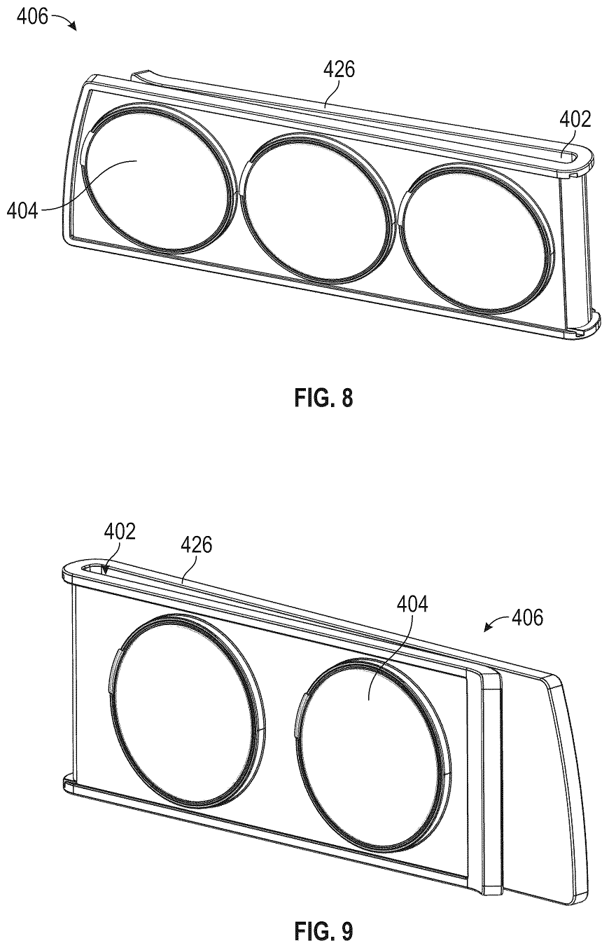

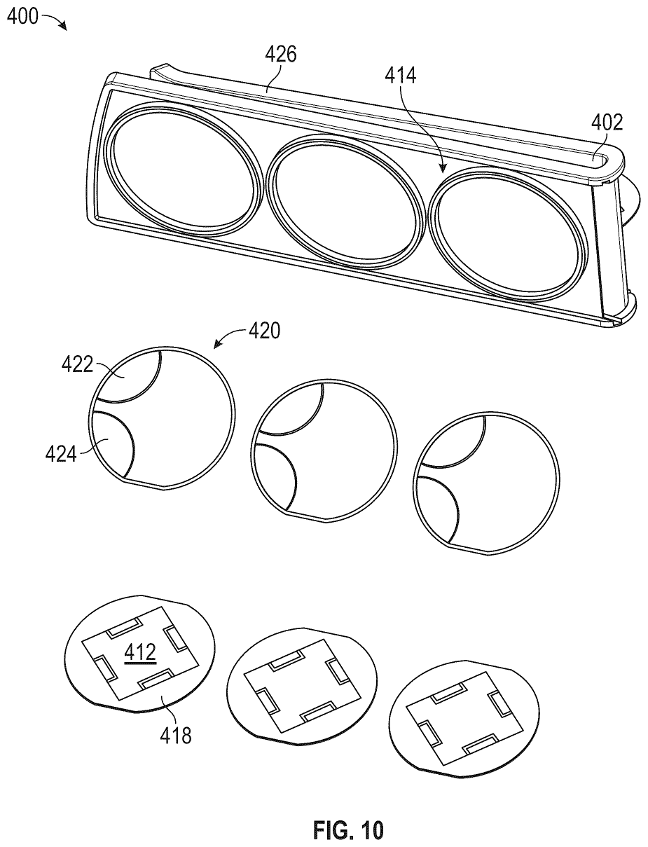

FIGS. 4-5 are front and rear views, respectively, of an embodiment of a tissue dispensing and disposal device, which may also be referred to as a handkerchief device 400. The handkerchief device 400 includes a passage 402 (see also FIGS. 8-10) configured to retain a cooperating handkerchief 490. The passage 402 may be, for example, a slot formed in handkerchief device 400, a sleeve, or another structure configured to receive a handkerchief therein. The handkerchief device 400 need not cooperate with a handkerchief, but may also or instead cooperate with another thin article such as a coat lining, a pocket, the strap of a bag, and so on. The handkerchief device 400 includes one or more expandable disposal portions 404, which may be configured to dispense a tissue. In the embodiment of FIGS. 4-5, three expandable disposal portions 404 are shown located on a front face of the handkerchief device 400, while two expandable disposal portions 404 are shown located on a rear face of the handkerchief device 400. It will be understood that more or fewer of the expandable disposal portions 404 may be present in various embodiments.

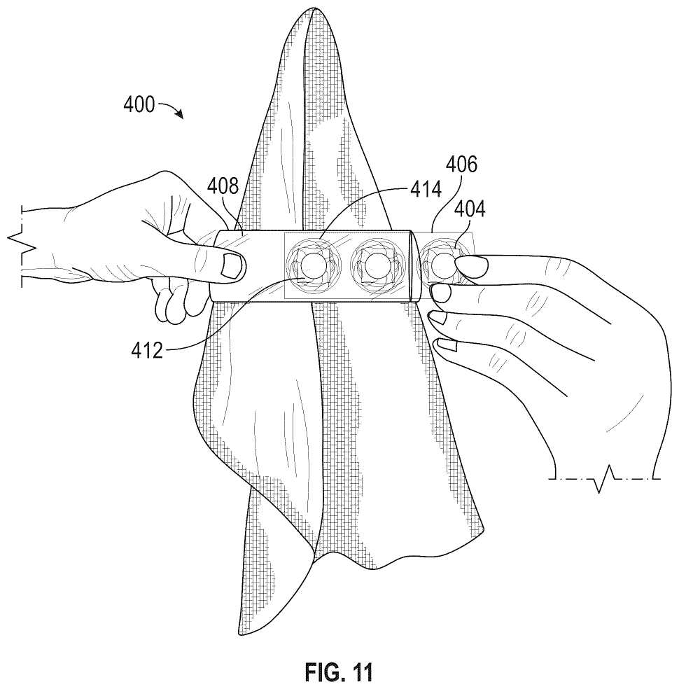

The handkerchief device 400 may include a support body 406 that supports one or more expandable disposal portions 404. The support body 406 may be slidably positioned to at least partially extend from handkerchief device 400, for example the support body 406 may be slid along the directional arrows of either of FIGS. 4-5. In some cases, a wrapper 408, such as a thin plastic sheet, may be affixed to an exterior of the passage 402, or another location, and may have an opening 410 on one or both ends. The support body 406 may be substantially surrounded by the wrapper 408 and may be slidably positionable within the wrapper 408 to extend through the opening 410 of the wrapper 408 (see, e.g., FIG. 11). When the support body 406 is thus positioned, the expandable disposal portions 404 may be exposed for removal from the handkerchief device 400. The wrapper 408 may be transparent, as indicated by the shading lines of FIGS. 4-5.

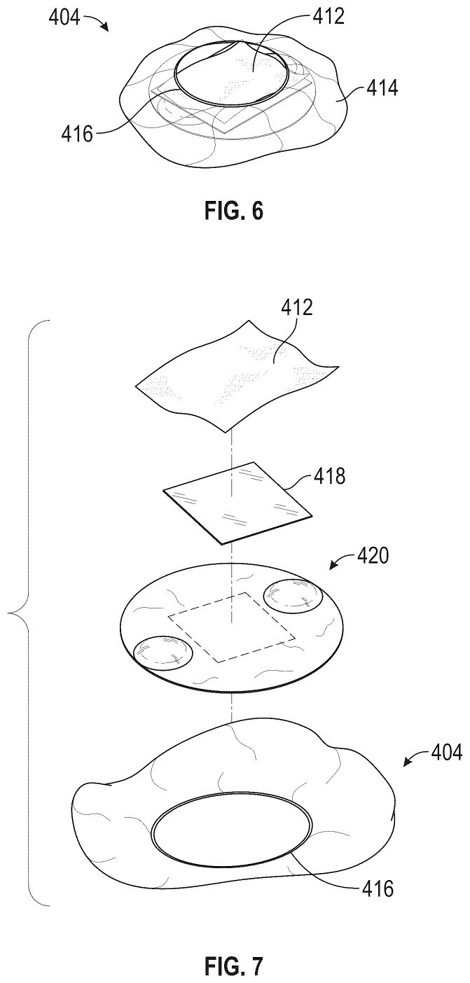

FIGS. 6-7 are perspective and exploded perspective views, respectively, of an embodiment of an expandable disposal portion 404. The expandable disposal portion 404 may be retained within a handkerchief device (e.g., the handkerchief device 400 of FIG. 4), such as by being located adjacent to the support body 406 within the wrapper 408. The expandable disposal portions 404 may be structured, for example, as an expandable bag which has an aperture 416 configured to receive a tissue 412 therethrough. The expandable disposal portion 404 is configured to receive the tissue 412 (e.g., a used facial tissue) through the aperture 416 for disposal of the tissue 412 within the expandable disposal portion 404.

In the shown embodiment, expandable disposal portion 404 has a layered structure, where the tissue 412, the expandable bag, a reflective region 418, and a dispensing region 420 are included as separate and distinct layers. The reflective region 418 may have a mirrored or otherwise reflective surface which a user may use to inspect their face. The dispensing region 420 may include, for example, a sanitizer dispenser and/or a moisturizer dispenser. It will be understood that some of these layers may not be present in all embodiments, and that other layers may also or instead be present.

FIGS. 8-10 are front perspective, rear perspective, and partially exploded perspective views, respectively, of another embodiment of the handkerchief device 400. As shown, the handkerchief device 400 may have a support body 406 that is structurally configured similarly to a clip. The passage 402 may be defined by the support body 406, and a handkerchief or similar article may be gripped by the support body 406, which may be formed of a resilient material (e.g., a resilient plastic). In other words, the support body 406 may be slipped over or clipped onto a handkerchief or similar article, as illustrated, e.g., in FIG. 4. Multiple expandable disposal portions 404 may be retained within the support body 406. The expandable disposal portions 404 may include features described elsewhere herein. For example, each expandable disposal portion 404 may include a tissue 412, a reflective region 418, and/or a dispensing region 420. The tissue 412 may in some cases be held in place against reflective region 418, for example, with an adhesive or retaining member, in a manner that permits easy removal of the tissue 412 from the reflective region 418. The dispensing region 420 may include a sanitizer dispenser 422 or a moisturizer dispenser 424, which may have a blister-pack type of construction that allows the user to break open the packaging with their hand and dispense a small amount of sanitizer or moisturizer. The expandable disposal portions 404 may also include an expandable bag, the aperture of which may be hidden from view in the present illustrations (e.g., the aperture may be located on the rear of expandable disposal portions 404).

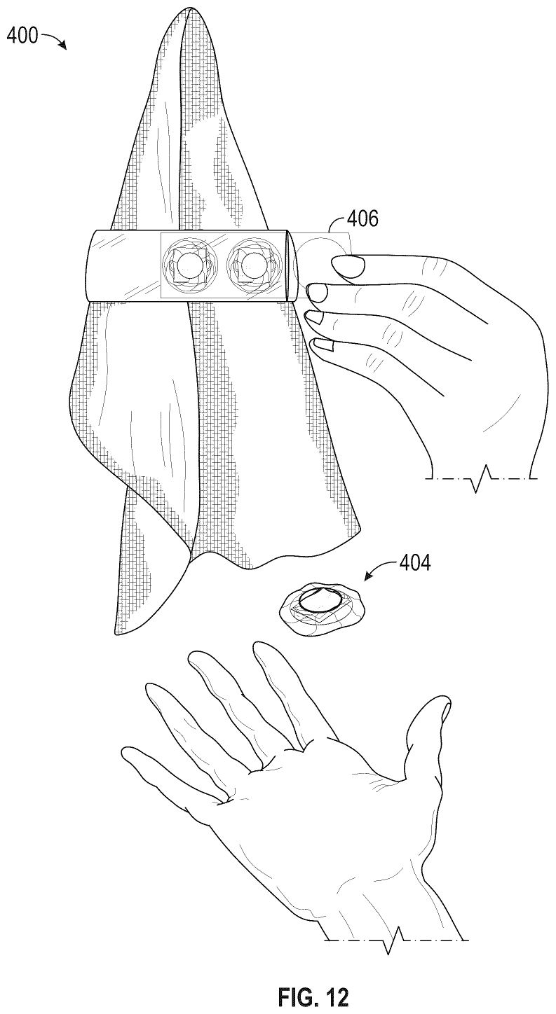

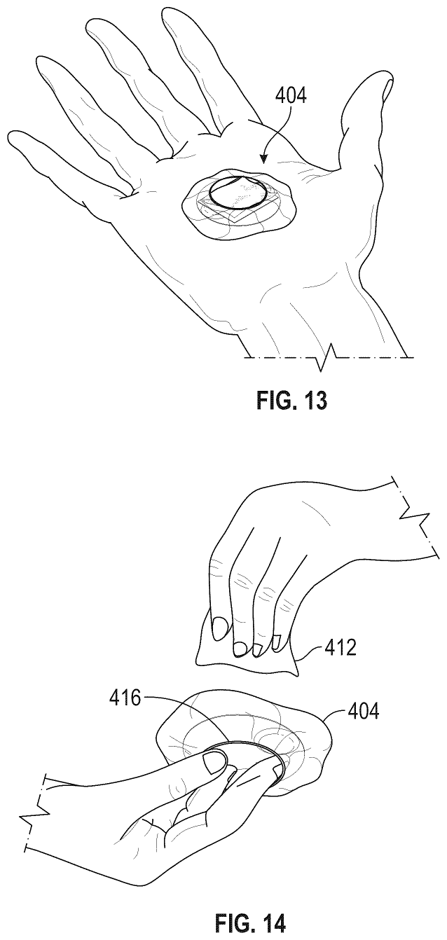

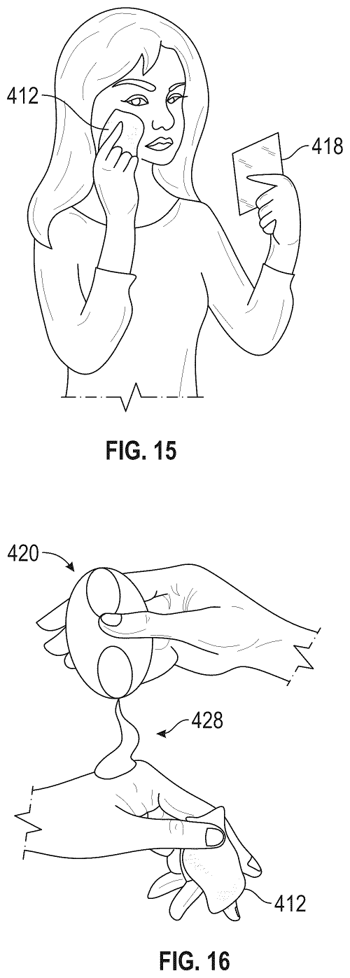

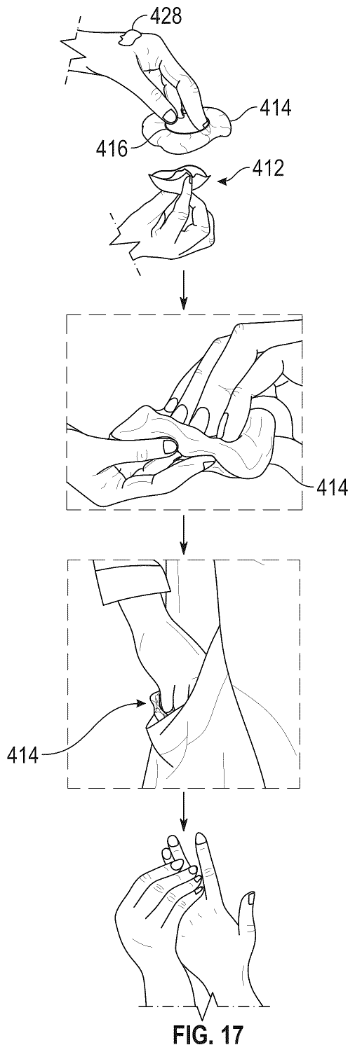

Referring now to FIGS. 11-17, methods of using a tissue dispensing and disposal device, such as handkerchief device 400, may include the following steps:
a) sliding a support body 406 out of a wrapper 408 through an opening 410 to expose at least one expandable disposal portion 404, which may include a tissue 412 and an expandable bag in a layered structure (see FIG. 11);
b) removing the exposed expandable disposal portion 404 from handkerchief device 400, which may include, for example, separating expandable disposal portion 404 from support body 406 (e.g., in a case where an adhesive backing may be used on expandable disposal portions 404), applying pressure to support body 406 to dislodge expandable disposal portions 404 therefrom (e.g., in a case where expandable disposal portions 404 may be held in position by a retainer), or similar (see FIG. 12);
c) holding expandable disposal portion 404, where in some cases expandable disposal portion 404 may be sized to fit in a palm of a user's hand (see FIG. 13);
d) removing tissue 412 from expandable disposal portion 404 (see FIG. 14);
e) using tissue 412 (see FIG. 15);
f) optionally, using reflective region 418 as a mirror (see FIG. 15);
g) dispensing sanitizer or moisturizer 428 from dispensing region 420 onto the user's hand (see FIG. 16);
h) disposing of used tissue 412 by inserting it through aperture 416 of the expandable bag (see FIG. 17);
i) disposing of expandable disposal portion 404 (such as by placing it in the user's pocket as shown in FIG. 17); and
j) applying sanitizer or moisturizer 428 to the user's hands (see FIG. 17).

The embodiments of the tissue dispensing and disposal devices and methods of use described herein are exemplary and numerous modifications, combinations, variations, and rearrangements can be readily envisioned to achieve an equivalent result, all of which are intended to be embraced within the scope of the appended claims. Further, nothing in the above-provided discussions of the device and method of use should be construed as limiting the invention to a particular embodiment or combination of embodiments. The scope of the invention is defined by the appended claims.

1. A tissue dispensing and disposal device comprising:
a support body;
one or more tissues supported by the support body and dispensable therefrom;
a plurality of expandable disposal portions affixed to the support body, each of the expandable disposal portions having an aperture configured to receive one of the one or more tissues therethrough and each of the expandable disposal portions being expandable to contain one of the one or more tissues; and
wherein each of the expandable disposal portions is structurally configured for separation from the support body.

2. The tissue dispensing and disposal device of claim 1, wherein the plurality of expandable disposal portions are affixed to an exterior face of the support body.

3. The tissue dispensing and disposal device of claim 1, wherein the one or more tissues are dispensable from a central region of the support body and the plurality of expandable disposal portions at least partially surround the central region.

4. The tissue dispensing and disposal device of claim 1, wherein the plurality of expandable disposal portions are each connected to another of the plurality of expandable disposal portions and are readily separable therefrom.

5. The tissue dispensing and disposal device of claim 4, wherein the plurality of expandable disposal portions, when connected to one another, form an accordion shape.

6. The tissue dispensing and disposal device of claim 1, further comprising an illumination source structurally configured to illuminate one or more of the plurality of expandable disposal portions.

7. The tissue dispensing and disposal device of claim 6, wherein the illumination source is located within the support body.

8. The tissue dispensing and disposal device of claim 1, further comprising a rotatable portion adjacent a top of the support body, the rotatable portion positionable to expose at least one of the expandable disposal portions.

9. The tissue dispensing and disposal device of claim 1, further comprising at least one of a sanitizer dispenser and a moisturizer dispenser affixed to the support body.

10. The tissue dispensing and disposal device of claim 1, further including one of a suction-type mount or an adhesive-type mount affixed to the support body.

11. The tissue dispensing and disposal device of claim 1, further including:
a passage shaped and dimensioned to retain a handkerchief;
a wrapper affixed to the passage and having an opening on an end;
the support body being located within the wrapper and slidably positionable within the wrapper along a first direction to extend through the opening;
the plurality of expandable disposal portions being retained adjacent to the support body within the wrapper; and
wherein, when the support body is slidably positioned to at least partially extend from the wrapper, at least one of the plurality of expandable disposal portions is exposed for removal from the device.

12. The tissue dispensing and disposal device of claim 11, wherein the passage is formed within a resilient clip.

13. The tissue dispensing and disposal device of claim 11, wherein each of the plurality of expandable disposal portions has a layered structure including a first layer including a reflective region, a second layer including at least one of a sanitizer dispenser and a moisturizer dispenser, and a third layer including an expandable bag.

14. The tissue dispensing and disposal device of claim 13, wherein the layered structure includes a fourth layer including one or more tissues.

15. The tissue dispensing and disposal device of claim 11, wherein the passage is sized to contain at least three handkerchiefs.

16. The tissue dispensing and disposal device of claim 11, wherein the wrapper has two openings, one of the two openings located on each of two opposing ends of the wrapper.

17. The tissue dispensing and disposal device of claim 11, further including: at least three expandable disposal portions retained adjacent to the support body within the wrapper, the at least three expandable disposal portions arranged linearly along the first direction.

18. The tissue dispensing and disposal device of claim 11, wherein, when the support body is slidably positioned to at least partially extend from the wrapper, the expandable disposal portion is ejected from the device.

19. A method of using a tissue dispensing and disposal device, the method including:
a) dispensing a tissue from a support body;
b) removing an expandable disposal portion from the device, the expandable disposal portion having an aperture configured to receive the tissue therethrough and being expandable to contain the tissue;
c) using the tissue;
d) after step c, disposing of the tissue by inserting it through the aperture of the expandable disposal portion;
e) dispensing at least one of a sanitizer and a moisturizer from a dispensing region;
f) disposing of the expandable disposal portion; and
g) applying at least one of the sanitizer and the moisturizer to a user's hand.

20. The method of claim 19, further including:
in step (a), sliding the support body out of a wrapper through an opening to expose at least one expandable disposal portion and at least one tissue.
